(19) United States
(12) Patent Application Publication
(10) Pub. No.: US 2001/0023739 A1
(43) Pub. Date: Sep. 27, 2001

(54) Process for producing liquid crystal device

(76) Inventors: Yasufumi Asao, Atsugi-shi (JP); Takeshi Togano, Chigasaki-shi (JP)

Correspondence Address: FITZPATRICK CELLA HARPER & SCINTO, 30 ROCKEFELLER PLAZA, NEW YORK, NY, 10112, US

(21) Appl. No.: 09/745,479

(22) Filed: Dec. 26, 2000

(30) Foreign Application Priority Data
Dec. 28, 1999 (JP) 375786
Dec. 20, 2000 (JP) 387885

(51) Int. Cl. B29C 47/00; B32B 31/00

(52) U.S. Cl. 156/244.22; 156/273.9

(57) ABSTRACT

A process for producing a liquid crystal device principally includes the steps of: disposing a pair of substrates each provided with an electrode with a spacing therebetween, and filling a chiral smectic liquid crystal in the spacing between the pair of substrates so as to be supplied with a voltage via the pair of electrodes. The pair of substrates are provided with anti-parallel uniaxial aligning axes so that the liquid crystal is placed in an alignment state exhibiting a pretilt angle of at least 4 degrees at a boundary thereof with at least one of the substrates. The liquid crystal has a phase transition series of Iso-Ch-SmC* or Iso-SmC* on temperature decrease. The process further includes a step of heating the liquid crystal disposed between the substrates to a temperature assuming Iso or Ch and then cooling the liquid crystal to a temperature assuming SmC*; and a step of applying an initial electric field having an effective voltage (Erms.) at a temperature assuming SmC* for at least 1 sec. to the liquid crystal via the electrodes so as to satisfy the following relationship:

Ps·Erms.>15[(nC/cm²)·(V/μm)]

wherein Ps denotes a spontaneous polarization of the chiral smectic liquid crystal.

### FIELD OF THE INVENTION AND RELATED ART

The present invention relates to a process for producing a liquid crystal device for use in light-valves for flat-panel displays, projection displays, printers, etc.

As a type of a nematic liquid crystal display device used heretofore, an active matrix-type liquid crystal device wherein each pixel is provided with a switching element (e.g., a thin film transistor (TFT)) has been known and used in various modes.

As a nematic liquid crystal material used for such an active matrix-type liquid crystal device using a TFT, there has been presently widely used a twisted nematic (TN) liquid crystal as disclosed by M. Schadt and W. Helfrich, “Applied Physics Letters”, Vol. 18, No. 4 (Feb. 17, 1971), pp. 127-128.

In recent years, there has been proposed a liquid crystal device of In-Plain Switching mode utilizing an electric field applied in a longitudinal direction of the device or of Vertical Alignment mode, thus improving a viewing angle characteristic being poor in the conventional liquid crystal displays.

In the case of using the nematic liquid crystal material, however, the resultant nematic liquid crystal display device has encountered a problem of a slow response speed.

In order to improve the response characteristic of the conventional types of nematic liquid crystal devices, a liquid crystal devices using a chiral smectic liquid crystal (free from the problem of a low response speed) has been proposed.

Such a chiral smectic liquid crystal device has been proposed, e.g., in U.S. patent application Ser. No. 09/338,426 (filed Jun. 23, 1999) wherein a chiral smectic liquid crystal has a phase transition series on temperature decrease of isotropic liquid phase (Iso)-cholesteric phase (Ch)-chiral smectic C phase (SmC*) or Iso-SmC* and liquid crystal molecules are monostabilized at a position inside an edge of a virtual cone. During the cooling step after injecting the chiral smectic liquid crystal between a pair of substrates (exactly during the phase transition of Ch-SmC* or Iso-SmC*), liquid crystal molecular layers are uniformly oriented or aligned in one direction, e.g., by applying a DC voltage of one polarity (+ or −) between a pair of substrates to improve high-speed responsiveness and gradation control performance and realize a high-luminance liquid crystal device excellent in motion picture image qualities with a high mass-productivity. The liquid crystal device of this type may advantageously be used in combination with switching elements such as a TFT because the liquid crystal material used has a relatively small spontaneous polarization.

In the above-mentioned monostabilized liquid crystal device, in order to provide liquid crystal molecules with a chevron structure in a parallel rubbing cell structure wherein uniaxial alignment axis directions (rubbing directions) of a pair of substrates are parallel to each other and directed in the same direction, the liquid crystal molecules may desirably be placed in C2 alignment state. However, according to our experiment, the C2 alignment state is difficult to be formed over the entire liquid crystal panel (cell), thus ordinarily resulting in an occurrence of a portion of C1 alignment state in almost all the cases. As a result, it has been found that a zig-zag texture (defect) is observed when viewed from a direction perpendicular to the panel surface. In this regard, it is possible to use an alignment control film capable of providing a low pretilt angle in order to alleviate a difference in characteristics between C2 and C1 alignment regions. In this case, however, it is difficult to obviate the presence of characteristic difference between C2 and C1 alignment regions unless the pretilt angle is controlled to be completely zero. As a result, an irregularity in voltage-transmittance (V-T) characteristic within a display panel area is liable to occur.

In order to prevent such an occurrence of V-T characteristic irregularity, in addition to use of the above-mentioned low pretilt alignment control film, it has been proposed a method wherein an alignment control film is subjected to rubbing treatment so as to provide an alignment control force in a prescribed range (Japanese Laid-Open Patent Application (JP-A) 2000-275685 (P2000-275685A).

According to this method, however, even when a black state is intended to be displayed, light leakage is liable to occur to some extent, thus lowing a contrast.

Further, the above-mentioned chiral smectic liquid crystal device (e.g., JP-A 2000-275685) effects a gradation display based on microdomain switching. When such a gradation display is performed in an enlarged display system (e.g., a projector-type liquid crystal panel using an enlarged projection system, a view finder or a head mount-type liquid crystal panel), microdomains per se are displayed in an enlarged state even if each microdomain has a small size (e.g., elliptical-shaped or rectangular-shaped monodomain has a shorter diameter or shorter side length of at most 10 μm). As a result, resultant images are liable to be deteriorated in image quality, particularly be roughened. Further, even in the case of a direct view-type liquid crystal panel (device), when the liquid crystal panel is high-definition one having a pixel pitch of at most 100 μm, it is difficult to sufficient ensure a gradation display performance within each pixel.

### SUMMARY OF THE INVENTION

An object of the present invention is to provide a process for producing a liquid crystal device capable of suppressing an occurrence of an alignment defect.

Another object of the present invention is to provide a process for producing a liquid crystal device capable of preventing a lowering in contrast.

According to the present invention, there is provided a process for producing a liquid crystal device, comprising the steps of:

disposing a pair of substrates each provided with an electrode with a spacing therebetween, and

filling a chiral smectic liquid crystal in the spacing between the pair of substrates so as to be supplied with a voltage via the pair of electrodes, wherein

the pair of substrates are provided with uniaxial aligning axes which are parallel but opposite to each other so that the liquid crystal is placed in an alignment state exhibiting a pretilt angle of at least 4 degrees at a boundary thereof with at least one of the substrates, and

the liquid crystal has a phase transition series of isotropic phase, cholesteric phase and chiral smectic C phase or a phase transition series of isotropic phase and chiral smectic C phase, respectively, on temperature decrease, and

said process further comprising:

a step of heating the liquid crystal disposed between the substrates to a temperature assuming isotropic phase or cholesteric phase and then cooling the liquid crystal to a temperature assuming chiral smectic C phase, and

a step of applying an initial electric field having an effective voltage (Erms.) at a temperature assuming chiral smectic C phase for at least 1 sec. to the chiral smectic liquid crystal via the electrodes so as to satisfy the following relationship:

Ps·Erms.>15[(nC/cm²)·(V/μm)]

wherein Ps denotes a spontaneous polarization of the chiral smectic liquid crystal.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIGS. 1 and 2 are respectively a schematic sectional view of an embodiment of a liquid crystal device produced by the production process of the present invention.

FIG. 3 is a schematic plan view of an embodiment of a liquid crystal device produced by the production process of the present invention.

FIG. 4 shows an equivalent circuit for each pixel portion.

FIG. 5 is a graph showing an example of a V-T (voltage-transmittance) characteristic of a liquid crystal device produced by the process of the invention.

FIG. 6 shows drive waveform diagrams (at (a), (b) and (c)) for driving a liquid crystal device produced by the process of the invention and a corresponding transmitted light quantity (at (d)).

### DETAILED DESCRIPTION OF THE PREFERRED EMBODIMENTS

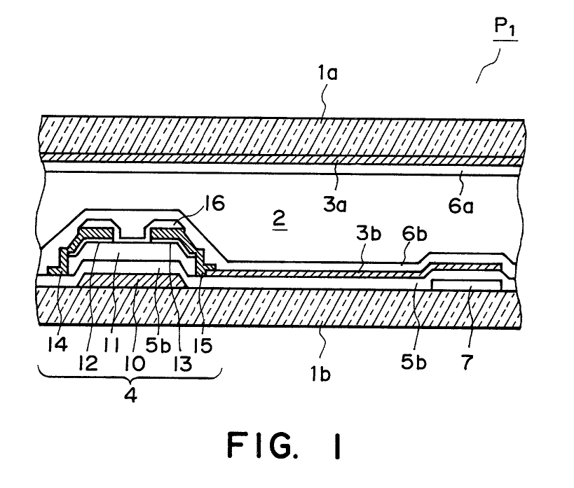

Hereinbelow, preferred embodiments of the present invention will be described with reference to FIGS. 1-6.

First, a cell structure of a liquid crystal device produced through the production process of the present invention will be explained with reference to FIGS. 1 and 2.

FIGS. 1 and 2 show cell structures of liquid crystal devices P1 and P2, respectively.

Referring to these figures, each of the liquid crystal devices P1 and P2 principally comprises a pair of substrates 1a and 1b, a pair of electrodes 3a and 3b disposed on the substrates 1a and 1b, respectively, and a chiral smectic liquid crystal 2 disposed at a spacing between the pair of substrates 1a and 1b (provided with the pair of electrodes 3a and 3b).

The liquid crystal device (P1 or P2) is driven by applying a voltage (driving voltage) to the chiral smectic liquid crystal 2 via the pair of electrodes 3a and 3b.

In the present invention, the pair of substrates 3a and 3b have been subjected to uniaxial alignment treatment (e.g., rubbing) so that uniaxial aligning axes are parallel but opposite to each other (i.e., anti-parallel relationship) and the chiral smectic liquid crystal 2 disposed therebetween is placed in an alignment state exhibiting a pretilt angle α of at least 4 degrees at a boundary thereof with at least one of the substrates 1a and 1b. In the present invention, the pretilt angle α is set to be below 50 deg., more preferably at least 4 deg. and below 30 deg.

The pretilt angle α referred to herein is a pretilt angle measured at a lower-limit temperature of Ch (cholesteric phase) when a chiral smectic liquid crystal material used shows Ch or a pretilt angle measured at an upper-limit temperature of SmC* when the liquid crystal material shows no Ch because it is particularly important that a pretilt angle value affecting a layer inclination angle at the time of first formation of layer structure of liquid crystal molecules on temperature decrease is taken into consideration.

At the above measuring temperature (lower-limit temperature of Ch or upper-limit temperature of SmC ), in the case where it is difficult to measure the pretilt angle or the pretilt angle shows no or substantially no temperature dependence, it may be possible to measure the pretilt angle at another arbitrary temperature. Alternatively, it is possible to employ a pretilt angle (measured in Ch or SmC*) of a liquid crystal composition comprising similar components to a chiral smectic liquid crystal actually used in the present invention, in place of the above-mentioned pretilt angle.

The chiral smectic liquid crystal 2 used in this embodiment may preferably have an alignment characteristic such that its liquid crystal molecules are aligned to provide an average molecular axis to be placed in a monostable alignment state under no driving voltage application, are tilted from the monostable alignment state in one (first) direction when supplied with a driving voltage of one (first) polarity at a tilting angle varying depending on magnitude of the supplied driving voltage (of first polarity), and are tilted from the monostable alignment state in the other direction (second direction opposite to the first direction) when supplied with a driving voltage of the other polarity (second polarity opposite to the first polarity) at a tilting angle varying depending on magnitude of the supplied driving voltage (of second polarity). In other words, the chiral smectic liquid crystal 2 loses its memory characteristic (or bistability) intrinsic thereto and can control continuously a magnitude of a resultant tilting angle (in the liquid crystal device) depending on magnitude of an applied voltage, thus continuously changing a (transmitted) light quantity of the liquid crystal device to allow gradation display. In this case, the tilting angle under application of the driving voltage of one (first) polarity may preferably provide a maximum tilting angle different from that given by the tilting angle under application of the driving voltage of the other (second) polarity. In a more preferred embodiment, the maximum tilting angle under application of the driving voltage of one polarity is at least 5 times as large as that under application of the driving voltage of the other polarity. The latter (smaller) maximum tilting angle (under application of the driving voltage of the other polarity may be substantially zero deg.).

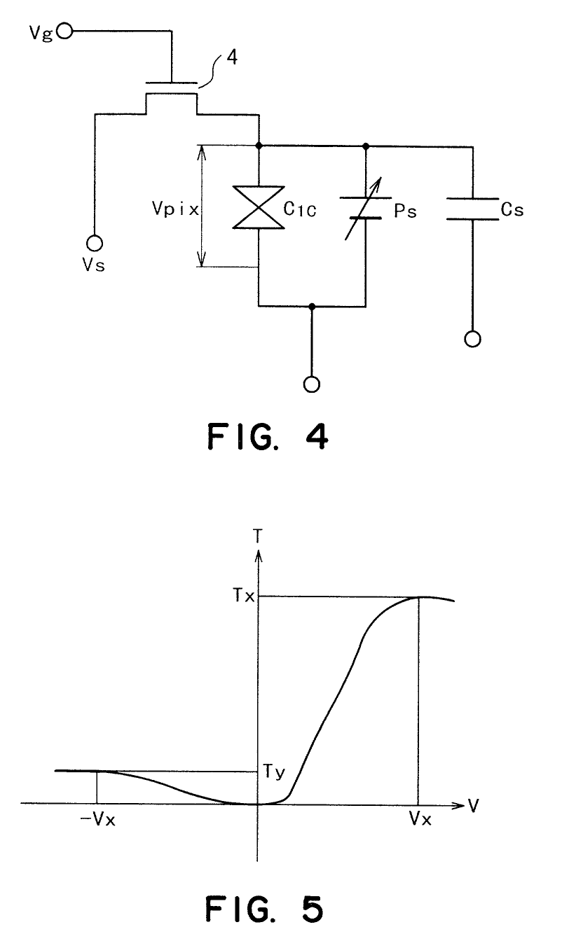

FIG. 5 is a graph showing an example of a relationship between a driving voltage (V) applied to a chiral smectic liquid crystal and a transmittance (T) of a chiral smectic liquid crystal device.

In FIG. 5, the above-mentioned one (first) polarity for the applied driving voltage is taken as a positive polarity and the other (second) polarity is taken as a negative polarity.

Referring to FIG. 5, on the positive (right) side, the transmittance (T) is gradually or gently increased continuously from zero to a maximum transmittance Tx with an increasing driving voltage from zero to a (saturation) driving voltage Vx.

On the other hand, on the negative (left) side, the transmittance is gradually increased continuously from zero to a maximum transmittance Ty with an increasing driving voltage (as an absolute value) from zero to a (saturation) driving voltage −Vx.

The maximum transmittance Ty under application of driving voltage (−Vx) of negative (second or the other) polarity is a very small value.

The maximum transmittances Tx and Ty are given at the maximum tilting angles under application of the positive- and negative-polarity driving voltages, respectively. Accordingly, when the maximum tilting angle is substantially zero deg., a resultant maximum transmittance Ty (under application of the negative-polarity driving voltage (−Vx)) is substantially zero %.

Further, the maximum tilting angles under application of the driving voltages (Vx and −Vx) corresponds to angles of at most 45 deg. Above 45 deg., a resultant transmittance does not correspond to a maximum value.

In the present invention, the chiral smectic liquid crystal 2 has a phase transition series of Iso-Ch-SmC* or Iso-SmC* on temperature decrease according to DSC (differential scanning calorimetry), thus not assuming smectic A phase (SmA) during a phase transition from higher-order phase (Iso or Ch) to SmC*.

Further, under no voltage application, the chiral smectic liquid crystal 2 may be stabilized inside a virtual cone edge for its liquid crystal molecules.

The chiral smectic liquid crystal 2 may preferably have a helical pitch which is at least two times as large as a cell gap (spacing between the substrates 1a and 1b) in a bulk state thereof.

The chiral smectic liquid crystal 2 may preferably be a liquid crystal composition prepared by appropriately blending a plurality of liquid crystal materials selected from hydrocarbon-type liquid crystal materials containing a biphenyl, phenyl-cyclohexane ester or phenyl-pyrimidine skeleton; naphthalene-type liquid crystal materials; and fluorine-containing liquid crystal materials.

The liquid crystal composition as the chiral smectic liquid crystal used in the present invention may preferably comprise at least two compounds each represented by the following formulas (1), (2), (3) and (4).

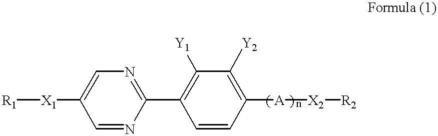

wherein A is

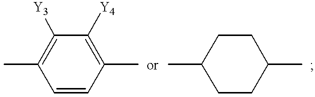

R1 and R2 are independently a linear or branched alkyl group having 1-20 carbon atoms optionally having a substituent; X1 and X2 are independently a single bond O, COO or OOC; Y1, Y2, Y3 and Y4 are independently H or F; and n is 0 or 1.

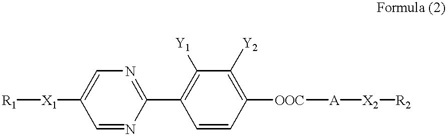

wherein A is

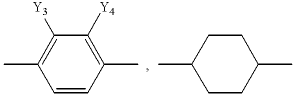

or —S— R1 and R2 are independently a linear or branched alkyl group having 1-20 carbon atoms optionally having a substituent; X1 and X2 are independently a single bond O, COO or OOC; and Y1, Y2, Y3 and Y4 are independently H or F.

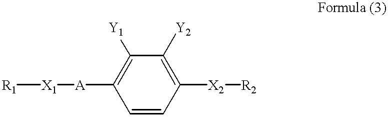

wherein A

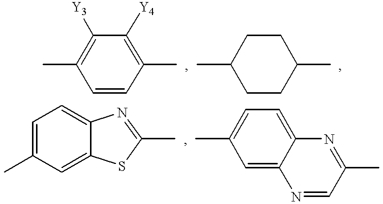

or

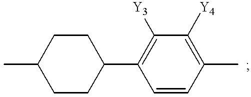

R1 and R2 are independently a linear or branched alkyl group having 1-20 carbon atoms optionally having a substituent X1 and X2 are independently a single bond O, COO or OOC; and Y1, Y2, Y3 and Y4 are independently H or F.

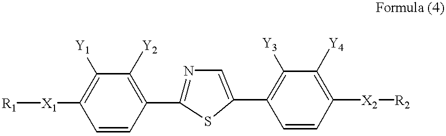

wherein R1 and R2 are independently a linear or branched alkyl group having 1-20 carbon atoms optionally having a substituent; X1 and X2 are independently a single bond, O, COO or OOC; and Y1, Y2, Y3 and Y4 are independently H or F.

Hereinbelow, respective structural members of the liquid crystal device P2 produced by the process according to the present invention will be described with reference to FIG. 2.

Referring to FIG. 2, the liquid crystal device P2 includes a pair of substrates 1a and 1b; electrodes 3a and 3b disposed on the substrates 1a and 1b, respectively; insulating films 5a and 5b disposed on the electrodes 3a and 3b, respectively; alignment control films 6a and 6b disposed on the insulating films 5a and 5b, respectively; a chiral smectic liquid crystal 2 disposed between the alignment control films 5a and 5b; and a spacer 8 disposed together with the liquid crystal 15 between the alignment control films 14a and 14b.

Each of the substrates 1a and 1b comprises a transparent material, such as glass or plastics, and is coated with, e.g., electrodes 3a (3b) of In₂O₃ or ITO (indium tin oxide) for applying a voltage to the liquid crystal 2.

On the electrodes 3a and 3b, the insulating films 5a and 5b, e.g., of SiO₂, TiO₂ or Ta₂O₅ having a function of preventing an occurrence of short circuit may be disposed, respectively, as desired.

On the insulating films 5a and 5b, the alignment control films 6a and 6b are disposed so as to control the alignment state of the liquid crystal 2 contacting the alignment control films 6a and 6b. The alignment control films 6a and 6b are subjected to a uniaxial aligning treatment (e.g., rubbing). Such an alignment control film 6a (6b) may be prepared by forming a film of an organic material (such as polyimide, polyimideamide, polyamide or polyvinyl alcohol) through wet coating with a solvent, followed by drying and rubbing in a prescribed direction or by forming a deposited film of an inorganic material through an oblique vapor deposition such that an oxide (e.g., SiO) or a nitride is vapor-deposited onto a substrate in an oblique direction with a prescribed angle to the substrate.

The alignment control films 6a and 6b may appropriately be controlled to provide liquid crystal molecules of the liquid crystal 2 with a prescribed pretilt angle α (an angle formed between the liquid crystal molecule and the alignment control film surface at a boundary with the alignment control film 6a or 6b) by changing the material therefor and treating conditions of the uniaxial aligning treatment.

The alignment control films 6a and 6b are subjected to the uniaxial aligning treatment (rubbing) so that the respective uniaxial aligning treatment (rubbing) directions may appropriately be set in an anti-parallel (parallel but directed oppositely) relationship. In the case of adopting a crossed relationship providing a crossing angle therebetween, the crossing angle may be set to be at most 45 degrees.

The substrates 1a and 1b are disposed opposite to each other via the spacer 8 comprising e.g., silica beads for determining a distance (i.e., cell gap) therebetween, preferably in the range of 0.3-10 μm, in order to provide a uniform uniaxial aligning performance and such an alignment state that an average molecular axis of the liquid crystal molecules under no electric field (driving voltage) application is substantially aligned with an average uniaxial aligning treatment axis (or a bisector of two uniaxial aligning treatment axes) although the cell gap varies its optimum range and its upper limit depending on the liquid crystal material used.

In addition to the spacer 8, it is also possible to disperse adhesive particles of a resin (e.g., epoxy resin) (not shown) between the substrates 1a and 1b in order to improve adhesiveness therebetween and an impact (shock) resistance of the chiral smectic liquid crystal device.

The liquid crystal device P1 or P2 shown in FIG. 1 or 2 is of a light-transmission type such that the pair of substrates 1a and 1b are sandwiched between a pair of polarizers (not shown) arranged in cross-nicol relationship (polarizing axes intersect with each other at right angles) to optically modulate incident light (e.g., issued from an external light source) through one of the substrates to be passed through the other substrate. The liquid crystal device produced by the process of the present invention may be modified into a reflection-type liquid crystal device by providing a reflection plate to either one of the substrates 1a and 1b or using a combination of one of the substrates per se formed of a reflective material or with a reflecting member thereon and the other substrate provided with a polarizer outside thereof.

In the present invention, the liquid crystal device P1 or P2 may be formed of a simple matrix-type or an active matrix-type. In the case of the simple matrix-type liquid crystal device, electrodes 3a and 3b may be formed as stripe electrodes arranged in a matrix form so that the stripe electrodes intersect each other at right angles. In the case of the active matrix-type liquid crystal device, one of the substrates (e.g., 1b in FIG. 1) is provided with a matrix electrode structure wherein dot-shaped transparent electrodes (e.g., 3b in FIG. 1) are disposed as pixel electrodes in a matrix form and each of the pixel electrodes is connected to a switching or active element, such as a TFT (thin film transistor) or MIM (metal-insulator-metal), and the other substrate may be provided with a counter (common) electrode (e.g., 3a in FIG. 1) on its entire surface or a part thereof in an prescribed pattern.

The liquid crystal device P1 or P2 produced by the process of the present invention may be used as a color liquid crystal device by providing one of the pair of substrates 1a and 1b with a color filter comprising color filter segments (each corresponding to each color pixel portion) of at least red (R), green (G) and blue (B). It is also possible to effect a full-color display by successively (sequentially) switching a light source system comprising R light source, G light source and B light source emitting color light fluxes to effect color mixing to change a resultant color image in synchronism with each color light emission in a field sequential manner.

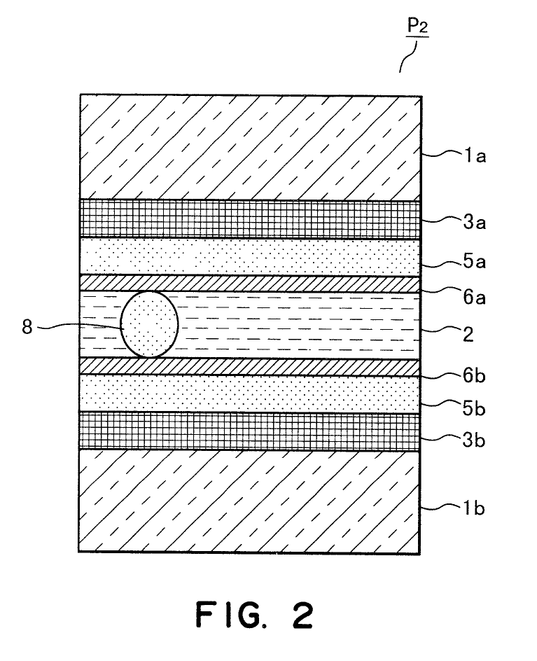

In the present invention, by using the above-mentioned liquid crystal device in combination with a drive circuit (e.g., 21 shown in FIG. 3) for supplying gradation signals to the liquid crystal device, it is possible to effecting a gradational display by electrically connecting the drive circuit with either one of the electrodes (e.g., 3b shown in FIG. 3).

Hereinbelow, an embodiment of the active matrix-type liquid crystal device P1 produced by the process of the present invention will be explained with reference to FIGS. 1 and 3.

The liquid crystal device P1 shown in these figures includes a pair of glass substrates 1a and 1b disposed opposite to each other with a prescribed spacing therebetween.

On the entire surface of one of the glass substrates (la in this embodiment), a common electrode 3a is formed in a uniform thickness and coated with an alignment control film 6a.

On the other glass substrate 1b, as shown in FIG. 3, scanning signal lines (gate lines) (G1, G2, G3, G4, G5, . . . ) which are arranged in an X direction and connected to a scanning signal driver 20 (drive means) and data signal lines (source lines) (S1, S2, S3, S4, S5, . . . ) which are arranged in a Y direction and connected to a data signal driver 21 (drive means) are disposed to intersect each other at right angles in an electrically isolated state, thus forming a plurality of pixels (5×5 in FIG. 3) each at intersection thereof. Each pixel is provided with a thin film transistor (TFT) 24 as a switching element and a pixel electrode 25. The scanning signal (gate) lines (G1, G2, . . . ) are connected with gate electrodes of the TFT 4, respectively, and the data signal (source) lines (S1, S2, . . . ) are connected with source electrodes 14 of the TFT 4, respectively. The pixel electrodes 3b are connected with drain electrodes 15 of the TFT 4, respectively.

In this embodiment, each pixel may be provided with an amorphous silicon (a-Si) TFT as the TFT 4. The TFT may be of a polycrystalline-Si (p-Si) type.

As shown in FIG. 1, the TFT 4 is formed on the glass substrate 1b includes: a gate electrode 10 connected with the gate lines (G1, G2, . . . shown in FIG. 3); an insulating film (gate insulating film) 5b of, e.g., silicon nitride (SiNx) formed on the gate electrode 10; an a-Si layer 11 formed on the insulating film 5b; n⁺ a-Si layers 12 and 13 formed on the a-Si layer 11 and spaced apart from each other; a source electrode 14 formed on the n⁺ a-Si layer 12; a drain electrode 15 formed on the n⁺ a-Si layer 13 and spaced apart from the source electrode 14; a channel protective film 16 partially covering the a-Si layer 11 and the source and drain electrodes 12 and 13. The source electrode 12 is connected with the source lines (S1, S2, . . . shown in FIG. 3) and the drain electrode 13 is connected with the pixel electrode 3b (FIG. 3) of a transparent conductor film (e.g., ITO film).

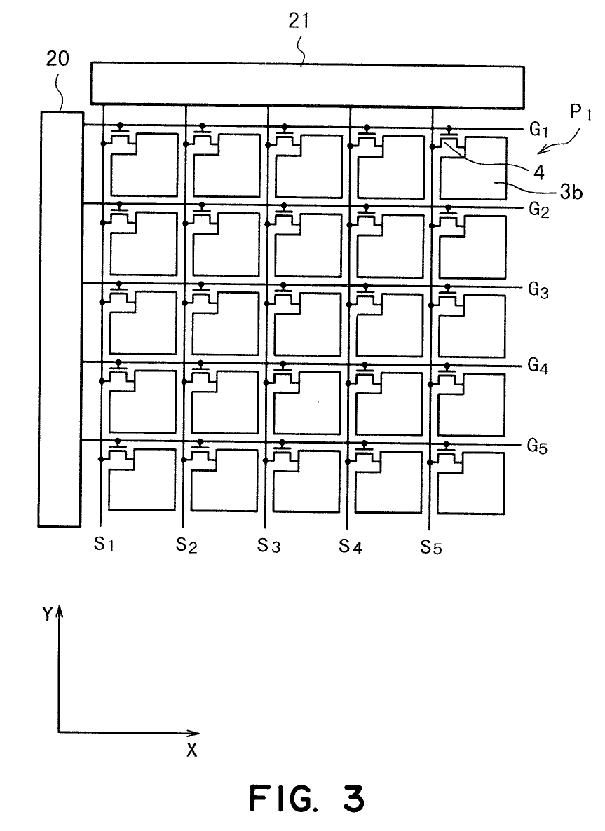

Further, on the glass substrate 1b, a structure constituting a holding or storage capacitor (Cs shown in FIG. 4) is formed by the pixel electrode 3b, a storage capacitor electrode 7 disposed on the substrate 1b, and a portion of the insulating film 5b sandwiched therebetween. The structure (storage capacitor) (Cs) is disposed in parallel with the liquid crystal layer 2. In the case where the storage capacitor electrode 7 has a large area, a resultant aperture or opening rate is decreased. In such a case, the storage capacitor electrode 7 is formed of a transparent conductor film (e.g., ITO film).

On the TFT 4 and the pixel electrode 3b of the glass substrate 1b, an alignment film 6b is formed and subjected to uniaxial aligning treatment (e.g., rubbing).

Between the pixel electrode 3b formed on the glass substrate 1b and the common electrode 3a formed on the glass substrate 1a, the chiral smectic liquid crystal 2 having a spontaneous polarization (Ps) is disposed to constitute a liquid crystal capacitor (C_{lc}) (FIG. 4).

The above liquid crystal device P1 shown in FIG. 1 is sandwiched between a pair of cross-nicol polarizers (not shown) (provided with polarizing axes disposed perpendicular to each other).

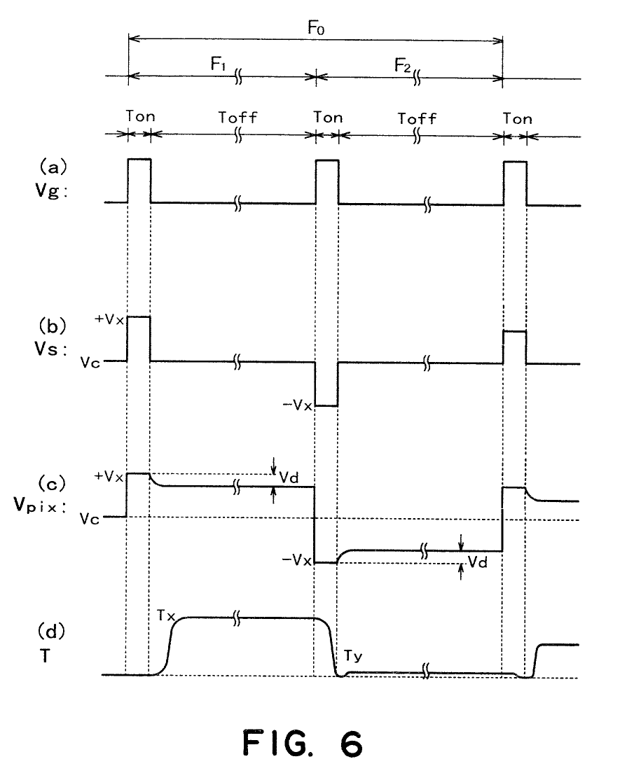

Next, an example of an ordinary active matrix driving method utilizing the active matrix-type liquid crystal device P1 will be described with reference to FIGS. 4 and 6 in combination with FIGS. 1 and 3.

In the above-mentioned liquid crystal device P1, a gate(-on) voltage is successively applied to each gate electrode (G1, G2, . . . ) from the scanning signal driver 20 in a line-sequential manner, whereby the TFT 4 is supplied with the gate voltage to be placed in an “ON” state.

In synchronism with the gate voltage application, source lines (S1, S2, . . . ) are supplied with a source voltage (a data signal voltage depending on writing information (data) for each pixel) from the data signal driver 21.

Accordingly, at a pixel where its TFT 4 is placed in an “ON” state, the source voltage is applied to the chiral smectic liquid crystal 2 via the TFT 4 and a corresponding pixel electrode 3b, thus allowing switching of the liquid crystal 2 for each pixel.

The above driving operation is repeated for a prescribed period (frame period) to effect re-writing of image.

In the case where such image re-writing operation is performed in each field period by dividing one frame period F0 into plural field periods (e.g., first and second field periods F1 and F2) as shown in FIG. 6, the following driving method may be applicable.

Referring to FIG. 6, at (a) is shown a waveform of gate voltage Vg applied to one gate line Gi; at (b) is shown a waveform of source voltage Vs applied to one source line Sj; at (c) is shown a waveform of voltage Vpix applied to the chiral smectic liquid crystal 2 at a pixel formed at an intersection of these gate and source line Gi an Sj; and at (d) is shown a change in transmitted light quantity T at the pixel. In this embodiment, the chiral smectic liquid crystal 2 used in the liquid crystal device P1 provides a V-T characteristic as shown in FIG. 5.

Referring again to FIG. 6, in one (first) field period (F1), one gate line Gi is supplied with a gate voltage Vg in a prescribed (selection) period Ton (as shown at (a)) and in synchronism with the gate voltage application, one source line Sj is supplied in the selection period Ton with a source voltage Vs (=V=+Vx) based on a potential Vc (reference potential) of a common electrode 3a (FIG. 1) (as shown at (b)) At this time, a TFT 4 at the pixel concerned is turned on by the application of gate voltage Vg and the source voltage Vx is applied to the liquid crystal 2 via the TFT 4 and a pixel electrode 3b, thus charging a liquid crystal capacitor Clc and a storage capacitor Cs.

In a non-selection period Toff other than the selection period Ton in the field period F1, the gate voltage Vg is applied to gate lines G1, G2, . . . , other than the gate line Gi. As a result, the gate line Gi is not supplied with the gate voltage Vg in the non-selection period Toff, whereby the TFT 4 is turned off. Accordingly, the liquid crystal capacitor Clc and storage capacitor Cs hold the electric charges charged therein, respectively, to provide the voltage Vx (=Vpix) through the field period F1 (as shown at (c)). The liquid crystal 2 supplied with the voltage Vx through the field period F1 provides a transmitted light quantity Tx substantially constant in the sub-field period F1 (as shown at (d)).

In the case where the response time of the liquid crystal is larger than the selection period Ton, the charging of the liquid crystal capacitor (Clc) and the storage capacitor (Cs) and a switching of the liquid crystal 2 are effected in the non-selection period Toff. In this case, the electrical charges stored in the capacitors are reduced due to inversion of spontaneous polarization to provide a driving (pixel) voltage Vpix smaller than the voltage +Vx by a voltage Vd applied to the liquid crystal layer 2 as shown at (c) of FIG. 6.

In the subsequent (second) field period F2, the above-described gate line Gi is again supplied with the gate voltage Vg (in Ton) (as shown at (a)) and in synchronism therewith, the source line Sj is supplied with a source voltage −Vs (=−Vx) (of a polarity opposite to that of the source voltage +Vx in F1) (as shown at (b)), whereby the source voltage −Vx is charged in the liquid crystal capacitor Clc and holding capacitor Cs in Ton and kept in Toff (as shown at (c)), thus retaining a transmitted light quantity Ty substantially constant in the field period F2 (as shown at (d)).

In the case where the response time of the liquid crystal is larger than the selection period Ton, the charging of the liquid crystal capacitor (Clc) and the storage capacitor (Cs) and a switching of the liquid crystal are effected in the non-selection period Toff. In this case, similarly as in the preceding field period F1, the electrical charges stored in the capacitors are reduced due to inversion of spontaneous polarization to provide a driving (pixel) voltage Vpix smaller than the voltage −Vx by a voltage Vd (as an absolute value) applied to the liquid crystal layer 2 as shown at (c) of FIG. 6.

In the above driving method shown in FIG. 6, switching of the chiral smectic liquid crystal 2 is performed for each field period (F1 or F2) depending on magnitude of an applied driving voltage to display gradational states (levels) (transmitted light quantities Tx and Ty) different between the field periods F1 and F2. As a result, in the entire frame period F0, the resultant transmitted light quantity becomes an average of Tx and Ty.

The transmitted light quantity Ty in the second field period F2 is considerably smaller than Tx (in the first field period F1) and closer to zero, whereby the resultant transmitted light quantity in the entire frame period F0 (F1+F2) is also lowered compared with Tx in the first field period F1. For this reason, in an actual drive of the liquid crystal device P1, based on an objective transmitted light quantity (gradational level of display image) through the entire frame period F0, a driving voltage Vx (−Vx) may preferably be determined appropriately by setting a transmitted light quantity Tx in the first field period F1 to be higher on than the objective transmitted light quantity.

In the above-mentioned driving method, a positive-polarity driving voltage (+Vx) is applied to the liquid crystal 2 in each odd-numbered field period (e.g., F1 shown in FIG. 6) and a negative-polarity driving voltage (−Vx) is applied to the liquid crystal 2 in each even-numbered field period (e.g., F2), whereby an overall driving voltage actually applied to the liquid crystal 2 is alternately changed (periodically) in polarity with time, thus effectively preventing deterioration of the liquid crystal 2.

Further, a higher luminance display is performed in the first field period F1 and a lower luminance display is performed in the second field period F2, thus resulting in a timewise aperture (opening) rate of at most ca. 50%. As a result, when motion pictures are displayed by using such a liquid crystal device P1, resultant image qualities become good.

Then, the process for producing a liquid crystal device according to the present invention will be specifically explained.

In the production process of the present invention, the following steps may be performed in an appropriate order:

a step of disposing a pair of substrates 1a and 1b with a prescribed spacing (gap) therebetween, a step of filling (disposing) a chiral smectic liquid crystal 2 in the spacing between the substrates 1a and 1b,

a step of forming a pair of electrodes 3a and 3b on the pair of substrates 1a and 1b, respectively, so as to sandwich the chiral smectic liquid crystal 2 in a resultant liquid crystal device, and

a step of subjecting each of the pair of substrates 1a and 1b to a specific uniaxial alignment treatment for aligning (or orienting) liquid crystal molecules.

More specifically, e.g., the process of the present invention may principally include the steps of: disposing a pair of substrates each provided with an electrode with a spacing therebetween, and filling a chiral smectic liquid crystal in the spacing between the pair of substrates so as to be supplied with a voltage via the pair of electrodes. In this case, the pair of substrates are provided with uniaxial aligning axes which are parallel but opposite to each other so that the liquid crystal is placed in an alignment state exhibiting a pretilt angle of at least 4 degrees at a boundary thereof with at least one of the substrates, and the liquid crystal has a phase transition series of isotropic phase (Iso), cholesteric phase (Ch) and chiral smectic C phase (SmC*) or a phase transition series of isotropic phase (Iso) and chiral smectic C phase (SmC*), respectively, on temperature decrease. The process further includes a step of heating the liquid crystal disposed between the substrates to a temperature assuming isotropic phase (Iso) or cholesteric phase (Ch) and then cooling the liquid crystal to a temperature assuming chiral smectic C phase (SmC*), and a step of applying an initial electric field having an effective voltage (Erms.) at the temperature assuming chiral smectic C phase for at least 1 sec. to the chiral smectic liquid crystal via the electrodes so as to satisfy the following relationship:

Ps·Erms.>15[(nC/cm²)·(V/μm)]

wherein Ps denotes a spontaneous polarization of the chiral smectic liquid crystal.

The effective voltage (Erms.) of initial electric field referred to herein is different from a driving voltage applied for displaying a prescribed image and specifically means a voltage given by a root-mean-square value for an applied waveform.

The initial electric field having such an effective voltage (Erms.) comprises a waveform providing a voltage varying (periodically) with time, such as a sine wave, a triangular wave or a sawtooth wave.

In the process of the present invention, the chiral smectic liquid crystal is supplied with a voltage comprising a DC voltage component in a temperature range within ±5° C. of a phase transition temperature to chiral smectic C phase (SmC*). At that time, the voltage may comprise a DC voltage component of 1-10 volts (as an absolute value).

Different from the liquid crystal device prepared by the process of the present invention described above, in the case of preparing a liquid crystal device providing a lower pretilt angle (α<4 deg.), liquid crystal molecules are assumed to form a (vertical) bookshelf structure immediately after a phase transition to a chiral smectic phase (i.e., formation of layers). Thereafter, a layer spacing is gradually decreased on temperature decrease to cause a change of the bookshelf structure toward such a structure that smectic layers are inclined or tilted from a direction normal to the substrate.

At that time, when a chevron layer structure is formed, the liquid crystal molecules are placed in C1 or C2 alignment state.

Further, when such a liquid crystal device is designed to provide an appropriate alignment control force, liquid crystal molecules form stripe textures and an oblique bookshelf structure. In this case, presumably, a (vertical) bookshelf structure is once formed immediately after the Ch-SmC* phase transition and then a layer spacing is gradually decreased on temperature decrease to change the tilted structure from the substrate normal direction due to a prescribed alignment control force, thus resulting in an oblique bookshelf structure, not the chevron structure. We assume that a minute ununiformity (irregularity) in layer structure during the charge of layer inclination angle with respect to the substrates is observed as stripe textures leading to image defects.

On the other hand, the liquid crystal device produced by the process of the present invention designed to provide a higher pretilt angle α of at least 4 degrees and an anti-parallel rubbing cell structure readily provides an oblique bookshelf structure which has already been formed from immediately after the phase transition to the (chiral) smectic phase (formation of layer structure). As a result, ununiform (irregular) layer structure of liquid crystal molecules of the chiral smectic liquid crystal is not readily formed in the liquid crystal device produced through the process according to the present invention, thus little causing an occurrence of stripe textures.

Even if some stripe textures are caused to occur in the liquid crystal device produced by the process of the present invention (using an anti-parallel cell providing a pretilt angle α of at least 4 deg.), the chiral smectic liquid crystal used is supplied with the above-mentioned initial electric field having an effective voltage (Erms.) (satisfying the relationship of Ps·Erms.>15[(nC/cm²)·(V/μm)]) for at least 1 sec., the stripe texture are effectively caused to disappear. In this regard, as a result of our experiment, in the case of the lower pretilt angle α of below 4 deg., the stripe textures still remain even when the initial electric field described above is applied. Accordingly, in order to effectively suppress the occurrence of stripe textures, it is important that the initial electric field application in the present invention is adopted in combination with a cell structure satisfying the anti-parallel relationship and the higher pretilt angle (α≧4 deg.), i.e., a cell structure not readily causing the above-mentioned ununiformity in layer structure of liquid crystal molecules.

In the present invention, the measurement of the pretilt angle α may be performed according to the crystal rotation method as described in Jpn. J. Appl. Phys. vol. 119 (1980), No. 10, Short Notes 2013.

For measurement, an anti-parallel rubbing liquid crystal cell provided with alignment treatment (rubbing) axes directed parallel but opposite to each other (so that liquid crystal molecules are tilted to form molecular layers in parallel with each other and tilted in the same direction at boundaries of a pair of substrates) was rotated in a plane perpendicular to the pair of substrates and including the aligning treatment axes (rubbing axes) and, during the rotation, the cell was illuminated with a helium-neon laser beam having a polarization plane forming an angle of 45 degrees with respect to the rotation plane in a direction normal to the rotation plane, whereby the intensity of the transmitted light was measured by a photodiode from the opposite side through a polarizer having a transmission axis parallel to the incident polarization plane.

A pretilt angle α was obtained through a simulation wherein a fitting of a spectrum of the intensity of the transmitted light formed by interference was effected with respect to the following theoretical curve (a) and relationship (b):

$$T ( φ ) = {cos}^{2} [ \frac{π d}{λ} ( \frac{NeNo \sqrt{{N}^{2} ( a ) - {sin}^{2} φ}}{{N}^{2} ( a )} - \sqrt{{No}^{2} - {sin}^{2} φ} - \frac{{Ne}^{2} - {No}^{2}}{{N}^{2} ( a )} sin a \cdot cos a \cdot sin φ ) ]$$

$$N ( a ) ≡ \sqrt{{No}^{2} \cdot {cos}^{2} a + {Ne}^{2} \cdot {sin}^{2} a}$$

(b), wherein No denotes the refractive index of ordinary ray, Ne denotes the refractive index of extraordinary ray, φ denotes the rotation angle of the cell, T(φ) denotes the intensity of the transmitted light, d denotes the cell thickness, and λ denotes the wavelength of the incident light.

Hereinbelow, the present invention will be described more specifically based on Examples.

### EXAMPLE 1

A chiral smectic liquid crystal composition LC-1 was prepared by mixing the following compounds in the indicated proportions.

| Structural formula | wt. % |
|---|---|
| 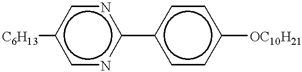 | 11.55 |
| 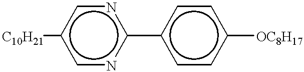 | 11.55 |
| 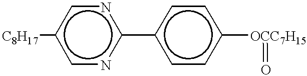 | 7.70 |
| 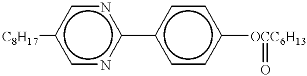 | 7.70 |
| 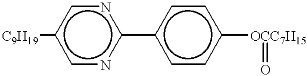 | 7.70 |
| 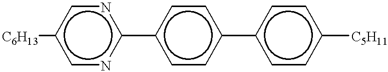 | 9.90 |
| 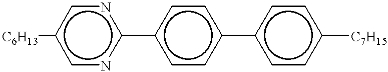 | 9.90 |
| 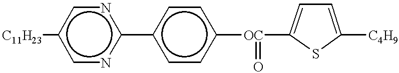 | 30.0 |
| 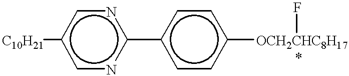 | 4.00 |

The thus-prepared liquid crystal composition LC-1 showed the following phase transition series and physical properties.

Phase Transition Temperature (C)

$$Iso {\to }^{86.3 } Ch {\to }^{ 61.2 } {Smc}^{*} {\to }^{ - 7.2 } Cry$$

(Iso: isotropic phase, Ch: cholesteric phase, SmC*: chiral smectic C phase, Cry: crystal phase)

Spontaneous polarization (Ps): 2.9 nC/cm² (30° C.)

Tilt angle \mathring{H}: 23.3 degrees (30° C.), AC voltage=100 Hz and ±12.5 V, cell gap=1.4 μm)

Layer inclination angle δ: 21.6 degrees (30° C.)

Helical pitch (SmC*): at least 20 μm (30° C.)

The values of phase transition temperature, spontaneous polarization Ps, tilt angle \mathring{H}, and layer inclination angle δ in smectic layer referred to herein are based on values measured according to the following methods.

Measurement of Phase Transition Temperature

The phase transition temperature was measured by using an DSC apparatus (“DSC Pyris 1”, applied from Perkin Elmer Co.) after the liquid crystal composition C-1 was subjected to such a treatment that the composition LC-1 was kept at 100° C. for 1 min., cooled at a rate of 5° C./min to −30° C. kept at −30° C. for 5 min., and heated again at a rate of 5° C./min to 100° C.

Measurement of spontaneous Polarization Ps

The spontaneous polarization Ps was measured according to “Direct Method with Triangular Waves for Measuring Spontaneous Polarization in Ferroelectric Liquid Crystal”, as described by K. Miyasato et al (Japanese J. Appl. Phys. 22, No. 10, pp. L661-(1983)).

Measurement of Tilt Angle \mathring{H}

A liquid crystal device was sandwiched between right angle-cross nicol polarizers and rotated horizontally relative to the polarizers under application of an AC voltage of ±12.5 V to +50 V and 1 to 100 Hz between the upper and lower substrates of the device while measuring a transmittance through the device by a photomultiplier (available from Hamamatsu Photonics K.K.) to find a first extinct position (a position providing the lowest transmittance) and a second extinct position. A tilt angle \mathring{H} was measured as half of the angle between the first and second extinct positions.

Measurement of Liquid Crystal Layer Inclination Angle δ

The method used was basically similar to the method used by Clark and Largerwal (Japanese Display '86, September 30-October 2, 1986, p.p. 456-458) or the method of Ohuchi et al (J.J.A.P., 27 (5) (1988), p.p. 725-728). The measurement was performed by using a rotary cathode-type X-ray diffraction apparatus (available from MAC Science), and 80 μm-thick microsheets (available from Corning Glass Works) were used as the substrates so as to minimize the X-ray absorption with the glass substrates of the liquid crystal cells.

A blank cell A was prepared in the following manner.

A pair of 1.1 mm-thick glass substrates each provided with a 700 Å-thick transparent electrode of ITO film was provided. In this example, patterning of the transparent electrodes was not performed.

On each of the transparent electrodes (of the pair of glass substrates), a polyimide precursor (“JALS2022”, mfd. by Japan Synthetic Rubber Co. Ltd.) was applied by spin coating and pre-dried at 80° C. for 5 min., followed by hot-baking at 200° C. for 1 hour to obtain a 150 Å-thick polyimide film.

Each of the thus-obtained polyimide film was subjected to rubbing treatment (as a uniaxial aligning treatment) with a nylon cloth under the following conditions to provide an alignment control film.

Rubbing roller: a 10 cm-dia. roller about which a nylon cloth (“NF-77”, mfd. by Teijin K.K.) was wound.

Pressing depth: 0.3 mm

Substrate feed rate: 10 cm/sec

Rotation speed: 1000 rpm

Substrate feed: 4 times

Then, on one of the substrates, silica beads (average particle size=1.5 μm) were dispersed and the pair of substrates were applied to each other so that the rubbing treating axes were in parallel with each other but oppositely directed (anti-parallel relationship), thus preparing a blank cell (single-pixel test cell) with a uniform cell gap.

The liquid crystal composition LC-1 was injected into the above-prepared blank cell in its cholesteric phase state and gradually cooled to a temperature providing chiral smectic C phase to prepare a liquid crystal device (single-pixel test cell).

In the above cooling step from Iso to SmC*, the device was subjected to a DC voltage application treatment such that a DC (offset) voltage of −5 volts was applied in a temperature range of Tc ±2° C. (Tc: Ch-SmC* phase transition temperature) while cooling the device at a rate of 1° C./min.

Separately, another blank cell (single-pixel cell) for pretilt angle measurement was prepared in the same manner as in the above-prepared blank cell except for using silica beads having an average particle size of 9 μm in place of those (average particle size =1.5 μm). Into the thus-prepared blank cell, the liquid crystal composition LC-1 was injected, followed by heating up to 62° C. (Ch phase temperature) and measurement of pretilt angle α according to the above-described crystal rotation method.

As a result, the pretilt angle α was 7.0 degrees.

The above-prepared liquid crystal device was evaluated in the following manner in terms of alignment state and optical response characteristics for rectangular wave, respectively.

<Alignment State>

The alignment state of the liquid crystal composition LC-1 of the liquid crystal device was observed through a polarizing microscope at 30° C. (room temperature) under no voltage application.

As a result, it was confirmed that stripe textures were formed over the entire display area to provide an angle of ca. 3 degrees between its average longitudinal direction and the rubbing direction.

Further, the stripe textures provided different positions of their darkest axes (i.e., a distribution of darkest axis position) to provide a maximum angle therebetween of ca. 4 degrees.

In the liquid crystal device, all the layer normal directions (of smectic molecular layers) were aligned in one direction over the entire display area.

<Optical Response to Rectangular Wave>

The liquid crystal device was set in a polarizing microscope equipped with a photomultiplier under cross nicol relationship so that a polarizing axis was disposed to provide the darkest state under no voltage application.

When the liquid crystal device was subjected to observation of inversion behavior through the polarizing microscope under application of a positive-polarity voltage of a rectangular wave (within ±5 volts, 60 Hz) while appropriately changing its voltage value, a plurality of minute regions including a portion inverted into a white display state were caused to occur. When the applied voltage was gradually increased, it was confirmed that an area of the inverted white portion was gradually enlarged. At that time, a resultant transmitted light quantity (transmittance) was gradually increased with the magnitude (absolute value) of the applied voltage irrespective of previous display state under application of the positive-polarity voltage. On the other hand, under application of the negative-polarity voltage, a resultant transmitted light quantity was changed with the applied voltage level but a maximum value of the transmittance was ca. 1/10 of a maximum transmittance in the case of the positive-polarity voltage application. Further, it was found that the resultant transmittance (optical response) of the liquid crystal device even under application of the positive and negative-polarity voltages was not affected by the previous state, thus attaining a good halftone image display state. Accordingly, even in the case where an image based on an average of transmittances given under application of positive and negative-polarity voltages is visually recognized by continuously applying the voltages to the liquid crystal device, it becomes possible to stably provide a display state (halftone image) which is not affected by its previous state.

Further, the liquid crystal device was subjected to measurement of a contrast in a temperature range of 10-50° C. under application of a rectangular wave (±5 V, 60 Hz).

As a result, the liquid crystal device exhibited a minimum contrast value of 120 at 10° C.

<Change by Strong Electric Field Application>

Separately, a liquid crystal device was prepared in the same manner as in the above-prepared liquid crystal device (for response characteristic evaluation).

The thus-prepared cell (after the DC voltage application) was subjected at 30° C. to an initial electric field application treatment for 10 sec. by using a triangular wave (maximum voltage=±18 volts, frequency=1 Hz) having an effective voltage Erms. providing Ps·Erms.=17.4[(nC/cm²)·(V/νm)].

When an alignment state of the chiral smectic liquid crystal was observed before and after the initial electric field application treatment, the stripe texture region occurred immediately after temperature increase completely disappeared and was confirmed to be changed in a domainless switching region accompanied with no occurrence of minute regions.

Thereafter, the liquid crystal device was subjected to measurement of a contrast in the above-mentioned manner, whereby the liquid crystal device exhibited a minimum contrast value of 200 at 10° C.

Next, another liquid crystal device for comparison was prepared in the same manner as in the above-prepared liquid crystal device (for response characteristic evaluation).

The thus-prepared cell (after the DC voltage application) was subjected at 30° C. to an initial electric field application treatment for 10 sec. by using a triangular wave (maximum voltage=±12 volts, frequency=1 Hz) having an effective voltage Erms. providing Ps·Erms.=11.6[(nC/cm²)˜(V/μm)].

When an alignment state of the chiral smectic liquid crystal was observed before and after the initial electric field application treatment, no change was confirmed.

Thereafter, the liquid crystal device was subjected to measurement of a contrast in the above-mentioned manner, whereby the liquid crystal device exhibited a minimum contrast value of 120 at 10° C.

Further, liquid crystal devices (prepared similarly as the one for initial electric field application treatment) were supplied with a sine wave and a rectangular wave, respectively, in place of the triangular wave.

As a result, the sine wave application provided a similar result as the triangular wave application at the same Ps·Erms.=(17.4 [(nc/cm²)·(V/μm)]) but in the case of the rectangular wave application, it was found that a higher (maximum) voltage value was required to achieve the similar result as the triangular wave.

### COMPARATIVE EXAMPLE 1

A liquid crystal device was prepared and evaluated in the same manner as in Example 1 except that a 50 Å-thick polyimide film was formed by using a polyimide precursor (“SE7992”, mfd. by Nissan Kagaku K.K.) and silica beads having an average particle size of 2.0 μm were used to provide a pretilt angle α of 2.0 degrees.

<Alignment State>

When, the alignment state of the liquid crystal composition LC-1 of the liquid crystal device was observed through a polarizing microscope at 30° C., it was confirmed that stripe textures were formed in an areal proportion of ca. 50% per the entire display area to provide an angle of ca. 3 degrees between their average longitudinal direction and the rubbing direction.

Further, the stripe textures provided different positions of their darkest axes (i.e., a distribution of darkest axis position) to provide a maximum angle therebetween of ca. 4 degrees.

In the liquid crystal device, all the layer normal directions (of smectic molecular layers) were aligned in one direction over the entire display area.

<Optical Response to Rectangular Wave>

When the stripe texture portion of the liquid crystal device was subjected to observation of inversion behavior through a polarizing microscope positive-polarity voltage similarly as in Example 1, a plurality of minute regions including a portion inverted into a white display state were caused to occur. When the applied voltage was gradually increased, it was confirmed that an area of the inverted white portion was gradually enlarged. At that time, a resultant transmitted light quantity (transmittance) was gradually increased with the magnitude (absolute value) of the applied voltage irrespective of previous display state under application of the positive-polarity voltage. On the other hand, under application of the negative-polarity voltage, a resultant transmitted light quantity was changed with the applied voltage level but a maximum value of the transmittance was ca. 1/10 of a maximum transmittance in the case of the positive-polarity voltage application. Further, it was found that the resultant transmittance (optical response) of the liquid crystal device even under application of the positive and negative-polarity voltages was not affected by the previous state, thus attaining a good halftone image display state.

On the other hand, a portion other than the stripe texture portion of the liquid crystal device C provided a uniform alignment state and was confirmed that at the portion a domainless switching accompanied with no occurrence of the above-mentioned minute regions was effected.

Further, under application of the negative-polarity voltage, a resultant transmittance was changed with the applied voltage level but a maximum value of the transmittance was ca. 1/10 of a maximum transmittance in the case of the positive-polarity voltage application.

Further, when the liquid crystal device was subjected to measurement of a contrast in the same manner as in Example 1, the liquid crystal device exhibited a minimum contrast value of 90 at 10° C.

<Change by Strong Electric Field Application>

Separately, a liquid crystal device was prepared in the same manner as Example 1.

The thus-prepared cell (after the DC voltage application) was subjected at 30° C. to an initial electric field application treatment in the same manner as in Example 1 except that an effective voltage Erms. provided Ps·Erms.=13.1 [nC/cm²)·(V/μm)].

When an alignment state of the chiral smectic liquid crystal was observed before and after the initial electric field application treatment, no change was confirmed.

Thereafter, the liquid crystal device was subjected to measurement of a contrast in the above-mentioned manner, whereby the liquid crystal device exhibited a minimum contrast value of 90 at 10° C., thus resulting in no change in contrast by the initial electric field application treatment.

### COMPARATIVE EXAMPLE 2

A liquid crystal device was prepared and evaluated in the same manner as in Comparative Example 1 except that the silica beads were changed to those having an average particle size o 1.5 μm. The device provided a pretilt angle of 2.0 deg. Further, due to the smaller particle size of the silica beads, an effective voltage Erms. in this comparative example provided Ps·Erms.=17.4[(nC/cm²)·(V/μm)].

Evaluation results of the thus-prepared liquid crystal device were similar to those of the device prepared in Comparative Example 1.

As described hereinabove, according to the present invention, it becomes possible to produce a liquid crystal device having a uniform layer structure of liquid crystal molecules, thus effectively suppressing occurrences of alignment defect and irregularity over the entire display area.

Further, it is possible to prevent a lowering in contrast since a relatively higher pretilt angle (α≧4 deg.) is adopted.

In addition, the resultant liquid crystal device allows gradation display with no microdomain switching, thus being suitable for a projector or a view finder.

The liquid crystal device also exhibits a high response speed.

What is claimed is:

1. A process for producing a liquid crystal device, comprising the steps of:
disposing a pair of substrates each provided with an electrode with a spacing therebetween, and
filling a chiral smectic liquid crystal in the spacing between the pair of substrates so as to be supplied with a voltage via the pair of electrodes, wherein
the pair of substrates are provided with uniaxial aligning axes which are parallel but opposite to each other so that the liquid crystal is placed in an alignment state exhibiting a pretilt angle of at least 4 degrees at a boundary thereof with at least one of the substrates, and
the liquid crystal has a phase transition series of isotropic phase, cholesteric phase and chiral smectic C phase or a phase transition series of isotropic phase and chiral smectic C phase, respectively, on temperature decrease, and
said process further comprising:
a step of heating the liquid crystal disposed between the substrates to a temperature assuming isotropic phase or cholesteric phase and then cooling the liquid crystal to a temperature assuming chiral smectic C phase, and
a step of applying an initial electric field having an effective voltage (Erms.) at a temperature assuming chiral smectic C phase for at least 1 sec. to the chiral smectic liquid crystal via the electrodes so as to satisfy the following relationship:
Ps·Erms.>15[(nC/cm²)·(V/μm)]
wherein Ps denotes a spontaneous polarization of the chiral smectic liquid crystal.

2. A process according to claim 1, wherein the initial electric field has a voltage varying with time.

3. A process according to claim 1, wherein the chiral smectic liquid crystal is supplied with a voltage comprising a DC voltage component in a temperature range within ±5° C. of a phase transition temperature to chiral smectic C phase.

4. A process according to claim 3, wherein the voltage comprises a DC voltage component of 1-10 volts.

5. A process according to claim 1, wherein the chiral smectic liquid crystal has an alignment characteristic such that liquid crystal molecules are aligned to provide an average molecular axis to be placed in a monostable alignment state under no driving voltage application, are tilted from the monostable alignment state in one direction when supplied with a driving voltage of one polarity at a tilting angle varying depending on magnitude of the supplied driving voltage, and are tilted from the monostable alignment state in the other direction when supplied with a driving voltage of the other polarity at a tilting angle varying depending on magnitude of the supplied driving voltage.

6. A process according to claim 5, wherein the tilting angle under application of the driving voltage of one polarity provides a maximum tilting angle different from that given by the tilting angle under application of the driving voltage of the other polarity.

7. A process according to claim 6, wherein the maximum tilting angle under application of the driving voltage of one polarity is at least 5 times as large as that under application of the driving voltage of the other polarity.

8. A process according to claim 1, wherein either one of the electrodes is connected to a drive circuit through which a gradation signal is supplied.

9. A process according to claim 1, wherein the chiral smectic liquid crystal has a helical pitch in its bulk state at least two times as large as a cell thickness.
